(19) United States
(12) Patent Application Publication
(10) Pub. No.: US 2026/0277557 A1
(43) Pub. Date: Sep. 17, 2026

(54) CODE GENERATION BASED ON VARIABLE ATTRIBUTES

(71) Applicant: NVIDIA Corporation, Santa Clara, CA (US)

(72) Inventors: Jeremy David FURTEK, San Antonio, TX (US); Cris CECKA, San Jose, CA (US); Kihiro BANDO, Mountain View, CA (US)

(73) Assignee: NVIDIA Corporation, Santa Clara, CA (US)

(21) Appl. No.: 19/081,754

(22) Filed: Mar. 17, 2025

(51) Int. Cl. G06F 8/34; G06T 1/20

(52) U.S. Cl. CPC G06F 8/34; G06T 1/20

(57) ABSTRACT

In various examples, a compiled code for execution of instructions on a host device including a graphics processing unit (GPU) and/or a central processing unit (GPU) is generated from a higher-level or intermediate representation. The code generation system can iteratively process functions of the input instructions by selecting an appropriate code generation function and selecting an appropriate variant of the code generation function. The variant of the code generation function can be selected based on a value of an attribute for a variable input to the function. A visitor configuration is used to cause the appropriate variant to be selected. By propagating values for a binding attribute of variables, statically defined code can be eliminated from the compiled output. In addition, memory allocation and layout can be optimized by propagating values for minimum, maximum, and/or divisibility attributes.

### BACKGROUND

Systems such as compilers generate machine executable code from higher-level programming languages. Some systems, such as compliers and/or interpreters, use syntax trees to analyze the structure of higher-level code. Generation of syntax trees is computationally intensive and can lead to long compile times. Systems and methods using syntax trees can incorrectly analyze code or not account for certain coding structures. Such issues can result in unexpected behavior and/or missed opportunities for optimizations such as precalculating statically defined variables. Missed opportunities compound and generated code (e.g., object code, assembly code, etc.) is ultimately less efficient.

### SUMMARY

Implementations of the present disclosure relate to code generation based on variable attributes. Systems and methods are disclosed that can implement certain functions with several different definitions based on the attributes of a variable that is input to the function. Variants of the functions can be defined differently for different values of attributes associated with a variable input to the function. During code generation, the system can determine the attribute values of the variable used as input to the function and can emit appropriate code for that variant. Selecting functions based on the variable variant can reduce the need for syntax trees and can improve efficiency of the code generation process.

In contrast to conventional systems, the variants of the function can calculate attributes for output variables differently, allowing variable attributes to be propagated through the system and used to perform code optimization. A binding attribute can be calculated for variables during the code generation process. The binding attribute may have a value of either static or dynamic and allow the code generator to generate code for which static variables are precalculated (rather than calculated at runtime).

Additionally or alternatively, minimum, maximum, and/or divisibility attributes can be maintained for variables during the code generation process. Such attributes can be used to further optimize code (e.g., determine optimal layouts for memory and/or processing unit allocation within a computer or graphics processing unit (GPU)). Such attributes can also be used to generate errors during compilation (e.g., at the time the code is generated) rather than waiting until runtime. Thus, developer efficiency can be enhanced, the number of computer operations can be reduced, and network traffic can be reduced (e.g., if the generated code is communicated over a network) by fixing issues prior to execution of the code.

At least one aspect relates to a one or more processors comprising processing circuitry. The processing circuitry can determine, from processing instructions, a function having an input variable comprising an attribute. The processing circuitry also can select a variant for the function from a plurality of variants for the function based at least on an input value of the attribute. The processing circuitry also can execute the variant of the function to determine an output value of the attribute of an output variable of the variant of the function based at least on the input value of the attribute.

In some embodiments, the processing circuitry also can generate compiled code by executing the variant of the function according to the output value of the attribute of the output variable. In some embodiments, the processing circuitry also can generate an error at a time of code generation based on at least one of, a comparison between the output value of the attribute of the output variable and an expected value of the attribute of the output variable, a comparison between the input value of the attribute of the input variable and an expected value of the attribute of the input variable, or a comparison between the attribute of the input variable and defined values of the attribute specified by the plurality of variants for the function.

In some embodiments, the attribute indicates whether a value of the input variable is known at a time of code generation. In some embodiments, the attribute indicates a minimum value and a maximum value of the input variable. In some embodiments, the attribute indicates one or more factors of the input variable. In some embodiments, the input variable comprises a shape or a stride for a memory allocation within a graphics processing unit.

Another aspect relates to a system with one or more processors to determine, from processing instructions, a function having an input variable comprising an attribute. The one or more processors also can select a variant for the function from a plurality of variants for the function based at least on an input value of the attribute. The one or more processors also can execute the variant of the function to determine an output value of the attribute of an output variable of the variant of the function based at least on the input value of the attribute. The one or more processors also can generate compiled code using the output value of the attribute.

In some embodiments, the one or more processors also can generate an error at a time of code generation based on at least one of: a comparison between the output value of the attribute of the output variable and an expected value of the attribute of the output variable, a comparison between the input value of the attribute of the input variable and an expected value of the attribute of the input variable, or a comparison between the attribute of the input variable and defined values of the attribute specified by the plurality of variants for the function.

In some embodiments, the attribute indicates whether a value of the input variable is known at a time of code generation. In some embodiments, the attribute indicates one or more factors of the input variable. In some embodiments, the input variable comprises a shape or a stride for a memory allocation within a graphics processing unit.

Another aspect relates to a method. The method includes determining, from processing instructions, a function having an input variable comprising an attribute. The method also includes selecting a variant for the function from a plurality of variants for the function based at least on an input value of the attribute. The method also includes executing the variant of the function to determine an output value of the attribute of an output variable of the variant of the function based at least on the input value of the attribute and generating compiled code using the output value of the attribute.

In some embodiments, the method also includes generating an error at a time of code generation based on at least one of a comparison between the output value of the attribute of the output variable and an expected value of the attribute of the output variable, a comparison between the input value of the attribute of the input variable and an expected value of the attribute of the input variable, or a comparison between the attribute of the input variable and defined values of the attribute specified by the plurality of variants for the function.

In some embodiments, the attribute indicates whether a value of the input variable is known at a time of code generation. In some embodiments, the attribute indicates one or more factors of the input variable. In some embodiments, the input variable comprises a shape or a stride for a memory allocation within a graphics processing unit.

### BRIEF DESCRIPTION OF THE DRAWINGS

The present systems and methods for code generation based on variable attributes are described in detail below with reference to the attached drawing figures, wherein:

FIG. 1 is a functional block diagram of an example system for generating code based at least on variable attributes suitable for use in implementing at least some implementations of the present disclosure.

FIG. 2 is a functional block diagram of an example code generator of the system of FIG. 1 suitable for use in implementing at least some implementations of the present disclosure.

FIG. 3 is a flow diagram of an example method for generating code based at least on variable attributes suitable for use in implementing at least some implementations of the present disclosure.

FIG. 4A is a block diagram of an example generative language model system suitable for use in implementing at least some implementations of the present disclosure;

FIG. 4B is a block diagram of an example generative language model that includes a transformer encoder-decoder suitable for use in implementing at least some implementations of the present disclosure;

FIG. 4C is a block diagram of an example generative language model that includes a decoder-only transformer architecture suitable for use in implementing at least some implementations of the present disclosure;

FIG. 5 is a block diagram of an example computing device suitable for use in implementing at least some implementations of the present disclosure; and

FIG. 6 is a block diagram of an example data center suitable for use in implementing at least some implementations of the present disclosure.

### DETAILED DESCRIPTION

This disclosure relates to systems and methods for code generation based on variable attributes, such as selecting one or more functions to generate code based on an evaluation of whether a variable is static, variables range, composite factors of a variable, or any other property that can be used to generate more efficient code or avoid runtime errors. Some systems can use syntax trees to perform code folding and/or eliminate dead code. Generation of syntax trees is computationally intensive and can lead to long compile times.

In addition to potentially long compilation times, systems and methods using syntax trees can incorrectly analyze code, leading to unexpected behavior and/or missed optimizations for the generated code (e.g., object code, assembly code, etc.). Some systems also report certain errors at runtime that could be discovered at compilation time or at a time of code generation, causing additional development time deploying code that ultimately will not behave correctly.

Systems and methods in accordance with the present disclosure can implement certain functions with several different definitions based on the attributes of the variable that is input to the function. The functions can be defined differently for different variable variants of the input to the function. During code generation, the system can determine the variant of the variable used as input to the function and can emit appropriate generated code for that variant. Selecting functions based on the variable reduces the need for syntax trees and can improve efficiency of the code generation process.

For example, the system can retrieve an intermediate representation of the code. The system can determine attributes associated with a particular variable and can execute the appropriate code generation function for the determined attribute. The code generation function may emit the necessary generated code as well as determine the attributes associated with any output variable from the function.

In some implementations, the system can assert attributes associated with the variables causing errors at the time of code generation if the attributes do not match their expected values. In some implementations, at least one attribute associated with a variable is a binding attribute. The binding attribute can include the value of static or dynamic. Functions that operate on a variable with a static binding attribute can output a static attribute and emit no code, whereas functions that operate on a variable with a dynamic binding attribute can output another variable with a dynamic attribute and can emit code to perform the function. In some implementations, at least one attribute associated with a variable is a range attribute. The range attribute indicates the maximum and minimum value that the variable can hold. Mathematical functions that operate on variables with a range attribute can calculate a new value for the range of the output variable. For example, a function that subtracts two numbers can calculate the range of the difference by determining the maximum of the range of the output variable with a difference between the maximum of the range for the minuend (e.g., first variable) and the minimum of the range for the subtrahend (e.g., second variable).

In some implementations, the code generation can target a central processing unit (CPU) and/or a graphics processing unit (GPU). The systems and methods in accordance with the present disclosure can be advantageously used to determine memory allocations for tensor objects. For example, statically defined tensors can have memory allocated in more efficient locations of a GPU where it is known that the size will not grow. In addition, the tensor size divisibility can be compared to the target hardware architecture to ensure efficient allocation.

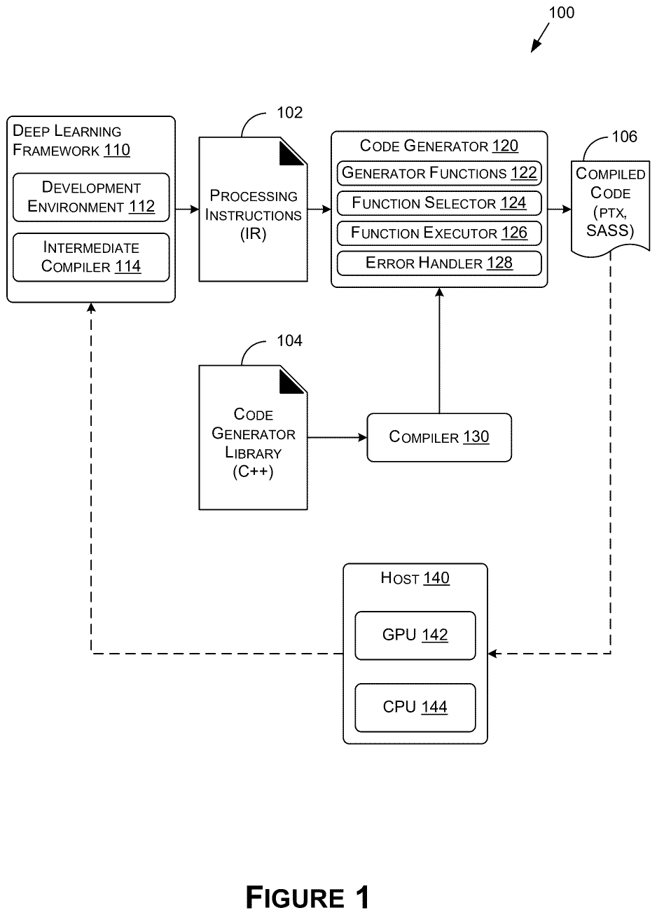

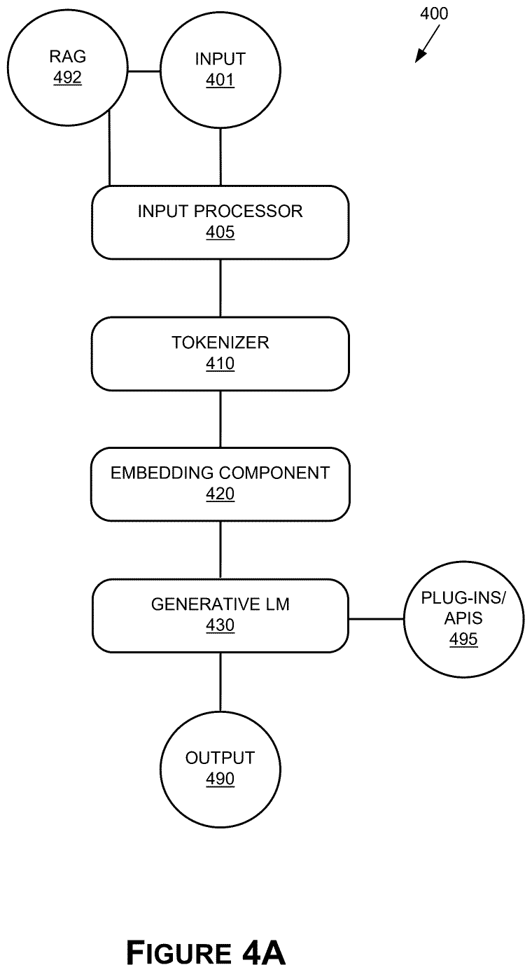

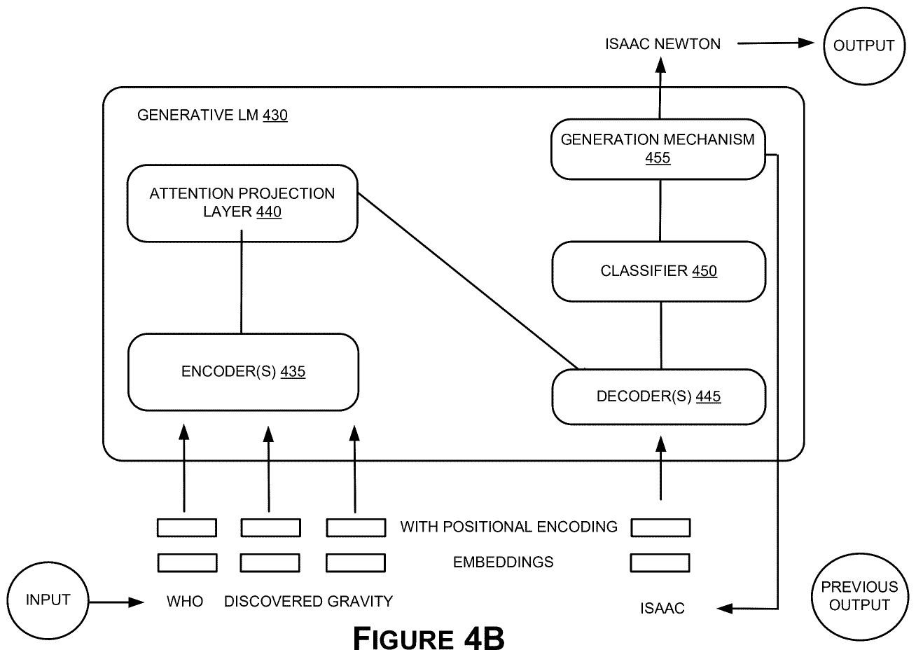

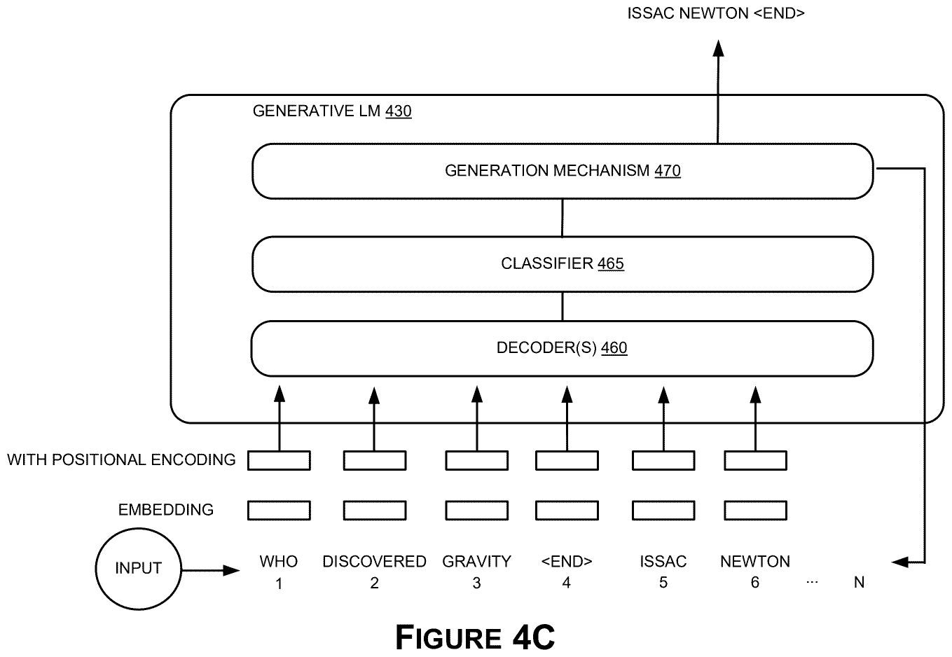

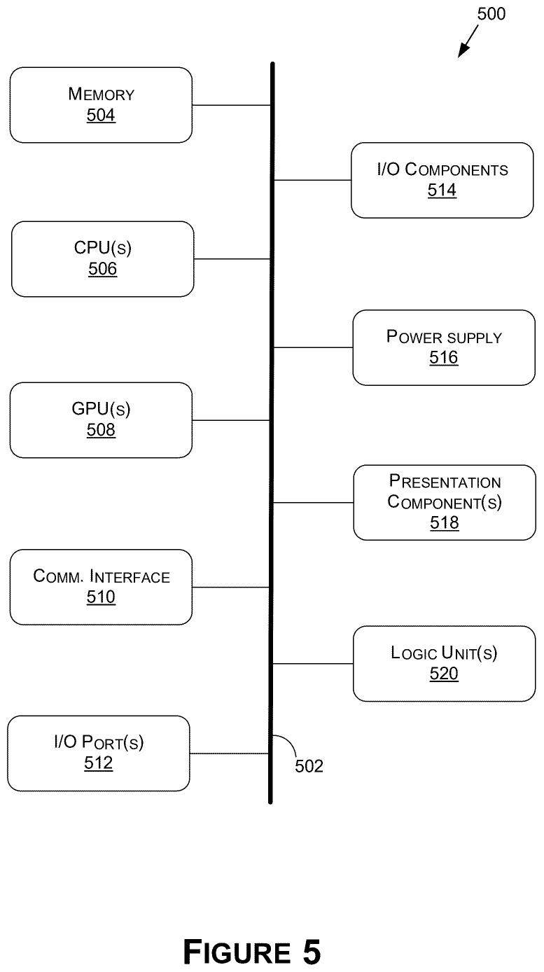

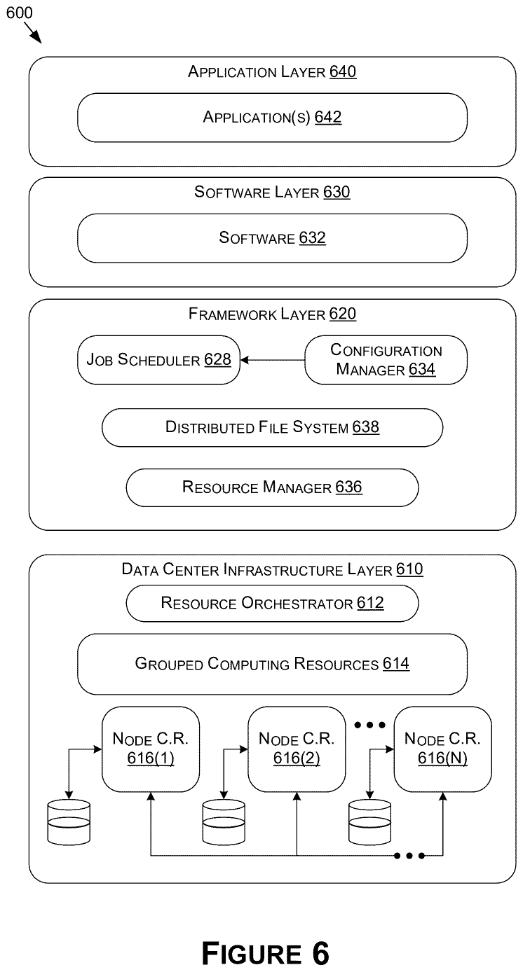

With reference to FIG. 1, FIG. 1 is an example of a system 100 for generating code based at least on variable attributes, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some implementations, the system and methods described herein may be implemented using one or more generative language models (e.g., as described in FIGS. 4A-4C), one or more computing devices or components thereof (e.g., as described in FIG. 5), and/or one or more data centers or components thereof (e.g., as described in FIG. 6).

The elements of the system 100 may be communicably connected within the system 100. In some implementations, one or more elements of the system 100 are included on the same device (e.g., hardware, computer, processing circuit, etc.). The one or more elements can, for example, be communicably connected over a bus or other hardware connection (e.g., ribbon cables, card edge connector, etc.). In some implementations, one or more elements of the system 100 are distributed across multiple devices. The one or more elements can, for example, be communicably connected over a network. The network can include local networks and/or wide area networks. The network can include routers, switches, antennas, computers, and any other hardware required to communicate information between the elements of the system 100. A portion of the network can be wireless and/or a portion of the network can be wired. The network can include one or more networks with routers to facilitate data transfer between the different networks. In some implementations, one or more elements of the system 100 are configured in a cloud architecture and can be implemented by one or more nodes in a computer cluster. The number of devices (e.g., hardware, computers, processing circuits, etc.) implementing an element in the system 100 can depend on the demand for that functionality. The system 100 can, in some implementations, scale the number of a particular element to add more computation power to a single element.

The system 100 can be used to generate machine executable instructions (e.g., assembly code, code for a device virtual machine, etc.) for deployment and execution on a host 140. Initial code creation can be performed by a developer (e.g., in a high-level language) using the deep learning framework 110. For example, the developer may be developing a training algorithm for a machine learning model on a GPU 142 of the host 140. The deep learning framework 110 can generate processing instructions 102 (e.g., in an intermediate representation) from the high-level code. A code generator 120 can include a compiled library of code generation functions (e.g., generator functions 122 compiled from the code generator library 104), and use the generator functions 122 to convert the processing instructions 102 into compiled code 106. The compiled code can then be deployed to and executed on the host 140. Details of these elements of the system 100 and the process performed by the elements are described in more detail herein.

The system 100 can include a deep learning framework 110. The deep learning framework 110 can generate processing instructions that can be used to generate low-level code (e.g., assembly, intermediate representations, machine code, etc.) such as parallel thread execution (ptx) and streaming assembler (SASS) suitable for implementation on a central processing unit (CPU) 144 and/or a graphics processing unit (GPU) 142.

The deep learning framework 110 can include a development environment 112, within which a developer develops code in a higher-level language. For example, the development environment 112 can provide an integrated environment for developing code in C, C++, Python, C#, R, Rust, F, Ruby, etc. The development environment 112 can include a text editor for creating and editing the code and a debugger for testing the code. In some implementations, the development environment 112 is integrated with an intermediate compiler 114. The development environment 112 can communicate code to the intermediate compiler 114, for example, to generate machine level code that executes instructions within the debugger and/or to generate a lower-level representation of the code for further code generation.

The deep learning framework 110 can include the intermediate compiler 114. The intermediate compiler 114 can generate lower-level code representations from the native code of the development environment 112. In some implementations, the compiler outputs processing instructions 102 in an intermediate representation (IR). For example, the compiler may output the processing instructions 102 in a low-level virtual machine (LLVM) format, a Microsoft intermediate language (MSIL) format, a common intermediate language (CIL) format, a standard portable intermediate representation (SPIR) format, etc.

In some implementations, the deep learning framework 110 provides an interface for the developer. The development environment 112 can receive information related to the success or failure of further compilation (e.g., from a code generator 120). The development environment 112 can also receive information related to the success or failure of the execution of the code on a host 140. For example, the development environment 112 can receive results from the host 140 as the code is running and/or after it has completed.

The system 100 can include a code generator 120 for receiving the processing instructions 102 (e.g., in an intermediate representation format, LLVM, etc.) and converting the processing instructions 102 into compiled code 106. The code generator 120 may receive the processing instructions 102 as input and operate upon the processing instructions 102 function-by-function (e.g., line-by-line, etc.). The code generator 120 can output (e.g., from operating upon the processing instructions 102) the compiled code 106. The compiled code 106, for example, can be another intermediate representation such as parallel thread execution (ptx), or assembly code such as streaming assembler (SASS), and/or other low-level or machine code suitable for implementation on a CPU 144 and/or a GPU 142 of the host 140. As described, the code generator 120 can convert function calls within the processing instructions 102 into low-level or machine code of compiled code 106.

The code generator 120 can include generator functions 122. The code generator 120 can call (e.g., execute, perform, evaluate, etc.) one or more of the generator functions 122 to generate the compiled code. The generator functions 122 can provide a library of functions for converting the portions of code (e.g., functions, lines, operations, etc.) of the processing instructions 102 to the compiled code 106. In some implementations, the generator functions 122 are organized by the function (e.g., the function name, identifier, or reference) and/or attributes of variables used as inputs to the function. Such an organization can facilitate selection by a function selector 124 based on at least the values of the attribute of the variables and/or the function.

Each generator function of the generator functions 122 can have a number of variants. The variant that is called may be based on the attributes of the input variables. A generator function can (i) emit code, (ii) generate additional variables used by later functions, (iii) generate an error. The outputs of a particular generator function can depend on the variant that is called. In addition, different functions (e.g., other arithmetic operations, determining the rank of a tensor, determining the right inverse, or allocating memory for a tensor) can have varying numbers of variants defined based on the values of different attributes (e.g., the binding attribute, a maximum attribute, a minimum attribute, a divisibility attribute, etc.).

One example of a function for which generator functions can be defined is multiplication. Multiplication may take in two inputs (e.g., the multiplier and the multiplicand). The operations of the generator function for the multiplication function may include generating output code (e.g., the compiled code 106) and/or generating an output variable that can be used as input to downstream code. Table 1 shows four example variants of a multiplication function for scalar values where the variant that is executed is based on at least a binding attribute of the input variables. A binding attribute can describe if the value of the variable is known at compilation time (e.g., static binding) or the value of the variable is not known until run time (e.g., dynamic binding). For the multiplication, if both the multiplier and the multiplicand have static values for their binding attribute, the output can be static (e.g., and equal to the product m1×m2). If any of the inputs are dynamic (e.g., variants B-D), the output variable can also include an attribute indicating the variable is dynamic (e.g., and equal to the value m1×m2). In addition, variants B-D may emit (e.g., generate, produce, output, etc.) code as part of the compiled code 106 to perform the operation m1×m2 at runtime.

TABLE 1
Variants of a generator function for multiplication.

| | Multiply | | | |
|---|---|---|---|---|
| | Multiplier <scalar> | Multiplicand <scalar> | | |
| | m1 | m2 | Output <scaler> | |
| | binding attribute | binding attribute | binding attribute | Emitted Code |
| Variant A | Static | Static | Static | None |
| Variant B | Static | Dynamic | Dynamic | m1 × m2 |
| Variant C | Dynamic | Static | Dynamic | m1 × m2 |
| Variant D | Dynamic | Dynamic | Dynamic | m1 × m2 |

In some implementations, a variable can have more than one attribute. Some attributes can be independently defined from other attributes. For example, the multiplier and the multiplicand can have a divisibility attribute indicating factors of the respective variable. The divisibility attribute can be independent of the binding attribute. A static variable 12, for example, can have a divisibility attribute with factors 1, 2, 3, 4, 6, and 12. A dynamic variable can also have a divisibility attribute with the same factors. In some implementations, a variant of a generator function can compute the values of attributes for output variables. The values calculated for the output variable may depend on the values of the input variables and/or the values of attributes of the input variables. For example, arithmetic generator functions can calculate values of maximum, minimum, and/or divisibility attributes for output variables based on values of maximum, minimum, and/or divisibility attributes for the input variables. Calculating the values of output attributes for arithmetic functions is described herein by way of example, multiplication, division, addition and subtraction.

For addition, a generator function (e.g., of the generator functions 122) can calculate (e.g., determine, compute, generate, etc.) the value of a maximum attribute for the output variable (e.g., the sum) by adding the maximums of both input variables; a generator function can calculate the value of the minimum attribute for the output variable by adding the minimums of both input variables; and a generator function can calculate the factors of a divisibility attribute for the output variable by determining the intersection of the factors of both inputs to the addition. For subtraction, a generator function can calculate the value of a maximum attribute for the output variable (e.g., the difference) by subtracting the minimum attribute of the subtrahend from the maximum attribute of the minuend; a generator function can calculate the value of a minimum attribute for the output variable by subtracting the maximum attribute of the subtrahend from the minimum attribute of the minuend; and a generator function can calculate the factors of a divisibility attribute for the output variable by determining the intersection of the factors of both inputs to the addition.

The generator functions 122 can also calculate the value of attributes for the outputs of multiplication and division operations. For (non-negative) multiplication, a generator function can calculate the value of a maximum attribute for the output variable (e.g., the product) by multiplying the maximums of both input variables; a generator function can calculate the value of the minimum attribute for the output variable by multiplying the minimums of both input variables; and a generator function can calculate the prime factors of a divisibility attribute for the output variable by concatenating the two inputs. For (non-negative) division, a generator function can calculate the value of a maximum attribute for the output variable (e.g., the quotient) by dividing the minimum attribute of the divisor by the maximum attribute of the dividend; a generator function can calculate the value of a minimum attribute for the output variable by dividing the maximum attribute of the divisor by the minimum attribute of the dividend; and a generator function can calculate the factors of a divisibility attribute for the output variable by removing the factors of the divisor from the factors of the dividend.

In some implementations, the divisibility attribute includes all factors. Alternatively, the divisibility attribute includes only the prime factors. In some implementations, the divisibility attribute includes the prime factors and their multiplicity. For example, the multiplication function can calculate an output divisibility attribute for prime factors by concatenating of the prime factors of the multiplicand and the multiplier and adding the multiplicity for those factors that are included in both attributes.

The function selector 124 can determine the function (e.g., of the generator functions 122) to execute based on the processing instructions 102. The function selector 124, for example, can resolve the name of the function in the processing instructions 102 to determine the correct generator function of the generator functions 122 that is to be executed. In addition, the function selector 124 can determine which variant of the generator function to call based at least on an attribute of an input to the function. The function selector 124 can provide the selection (e.g., by way of a memory address for the function, code for the selection, or other indication of which function and variant is to be executed) to the function executor 126. In some implementations, the function selector 124 can also select the variant of the function based on the type of the input variable (e.g., scalar, vector, numeric, textual, etc.)

The code generator 120 can include a function executor 126. The function executor 126 can execute the function selected by the function selector 124. The function executor 126 can receive the function selection and any input variables. The function executor 126 can generate code in the compiled language (e.g., an intermediate representation, assembly, or machine code) by executing the selected generator function of the generator functions 122. Additionally or alternatively, the function executor 126 can compute output variables and values for respective attributes of the output variables by executing the selected generator function of the generator functions 122.

In some implementations, the function executor 126 can cause an exception during execution and provide the exception to the error handler 128 for additional processing. For example, the selected generator function (e.g. of the generator functions 122) may assert values of the attributes of the input or output variables of the function and generate an exception if the asserted attributes do not satisfy a match criterion with respective expected values. For example, in some implementations, an error is generated if both inputs to a division function are static and the dividend does not have a factor of the divisor (e.g., indicating that the division would produce a remainder). In some implementations, multiple of the same function types are available (e.g., some that generate exceptions and others that do not). The function executor 126 can choose to run a function with or without generating errors based on the current state of functional processing within the code generator 120. Additionally or alternatively, the function executor 126 can generate one or more exceptions that can be ignored, processed, or cause processing to be stopped, based on the severity, the current state of processing, and/or the configuration of the code generator 120.

The code generator 120 can include an error handler 128. The error handler 128 can determine errors at compilation time (e.g., the time of code generation) based on values of the attributes. Advantageously, the impropriety of the code can be communicated to the developer earlier (e.g., before investing time in the deployment and execution of the code on the host 140) and the overall number of computations, development time, and/or network traffic can be reduced. In some implementations, the error handler 128 can generate an error if the function selector 124 fails to find a function with a matching attribute signature (e.g., if no variant is defined for the particular combination of values of input attributes). In some implementations, the error handler 128 can perform a corrective action for an error and allow processing to continue. The error handler 128 can, for example, store the error to be presented to the user, but continue processing to allow additional potential errors to be identified.

In some implementations, the error handler 128 performs operations using output variables that have a relationship with the target hardware of the host 140 (e.g., the CPU 144 or the GPU 142). For example, to ensure efficient operation, the error handler 128 can assert that the size of the allocation fits within the predefined units of memory of the host 140 using the divisibility properties. Additionally or alternatively, the error handler 128 can compare the maximum attribute of a size output variable to a threshold of total resources to determine if there are sure to be enough resources at runtime, and/or the error handler 128 can compare the minimum attribute of a size output variable to the threshold of total resources to determine if the fit is possible.

The host 140 can receive the compiled code 106 from the code generator 120 for execution within the CPU 144 and/or the GPU 142. In some implementations, the host 140 communicates the results back to the deep learning framework 110 for review by the developer.

The compiled code 106 can include a variant of functions that are performed on the GPU 142 and/or the CPU 144. The compiled code 106 can be graphics calculations for a rendering of a three-dimensional model. For example, the compiled code 106 can be a portion of a video game or a portion of a three-dimensional simulation of an industrial process. Additionally or alternatively, the compiled code 106 can be a portion of a training algorithm for machine learning models (e.g., neural networks, transformer models, reinforcement learner, etc.). Nonlimiting examples, of the operations instructed by the compiled code 106 include defining a tensor layout with a shape and stride, allocating memory for a tensor, tiling tensors to parallelize operations, determining the rank of a tensor, determining the size of a tensor, slicing a tensor, performing an addition, performing a division, etc.

In some implementations, the system 100 includes a code generator library 104. The code generator library 104 can include the higher-level definitions of the generator functions 122 (e.g., in C, C++, or other suitable coding language). The code generator library 104 can also include definitions the other components of the code generator library 104. For example, the code generator library 104 may include definitions (e.g., code, instructions, etc.) for the function selector 124 and/or the error handler 128.

In some implementations, the code generator library 104 uses a visitor configuration to define the variants of the generator functions 122. A visitor object can return generator functions 122 based on the values of the attributes for the input variables. A visitor for a multiply function can be defined as:

```
struct mlir_dynamic_t : dynamic_t {
  mlir::Value value;
};
class rec_var : public std::variant<int,
    mlir_dynamic_t,
    std::vector<rec_var>>;
struct mlir_multiply_visitor {
  rec_var operator( )(int lhs, const mlir_dynamic_t& rhs) {
    mlir::Value vlhs = builder−>create<mlir::arith::ConstantOp>(/*...*/, lhs);
    mlir::Value vres = builder−>create<mlir::arith::MulIOp>(/*...*/, vlhs, rhs.value);
    return mlir_dynamic_t(vres);
}
  rec_var operator( )(const mlir_dynamic_t& lhs, const mlir_dynamic_t& rhs) {
    mlir::Value vres = builder−>create<mlir::arith::MulIOp>(/*...*/, lhs.value,
rhs.value);
  return mlir_dynamic_t(vres);
}
};
```

As shown in the above code, when the multiply visitor visits variables for a multiplier and a multiplicand, the respective generator functions 122 (e.g., based on whether the multiplier or left-hand side is dynamic) can be performed. The example code shows two operators for the multi-level intermediate representation (MLIR) multiplier function. In the first operator (e.g., a generator function 122) for a constant multiplier and a dynamic multiplicand, MLIR functions are shown to be generated that create the constant multiplier and perform the multiplication. In addition, the example code shows a dynamic variable is returned. In the second operator (e.g., another variant of the multiplier generator function above) for a dynamic multiplier and a dynamic multiplicand, MLIR functions are shown to be generated that perform the multiplication and return a dynamic multiplier.

The infrastructure of the visitor configuration can define the function selector 124 by selecting the appropriate function from those defined in the visitor class. Additionally or alternatively, the infrastructure of the visitor paradigm can define the error handler 128 by causing an error when inappropriate functional inputs are provided. For example, if the visitor does not contain an operator for the objects being visited, an error may be generated. Advantageously, the error can occur prior to run time (e.g., at the time code is compiled or generated). The code above is intended to be exemplary of the visitor paradigm and in no way limiting the scope of the disclosure herein. In some implementations, the code generator library 104 additionally or alternatively defines instructions to convert the processing instructions 102 (e.g., in C, MLIR, LLVM, or other intermediate representation) and generate compiled code 106 (e.g., in MLIR, LLVM, PTX, or other intermediate representation; SASS or other assembly code; or machine code) using other configurations.

In some implementations, the visitor configuration provides instructions by which the code generator 120 is able to eliminate dead code. For example, the visitor configuration provides instructions by which the binding attributes of variables are propagated through the processing instructions 102 during the code generation process by evaluating static variables without producing code. The visitor configuration can allow for code optimization without computationally and/or memory intensive strategies such as syntax trees. The visitor configuration can also provide instructions to propagate other variable attributes through the instructions defined in the processing instructions 102. Additional variants of the generator functions can be defined for the necessary values of other attributes (e.g., minimum, maximum, divisibility, or any other attribute that can be used to generate more efficient code).

A compiler 130 may be used to convert the code generator library 104 into executable instructions (e.g., operations, commands, etc.) for the code generator 120. In some implementations, the compiler generates additional instructions such that the code generator 120 can be integrated with the deep learning framework 110, for example, using the same development environment 112. Advantageously, integrating the code generator 120 with the development environment 112 can provide a simplified experience for the developer.

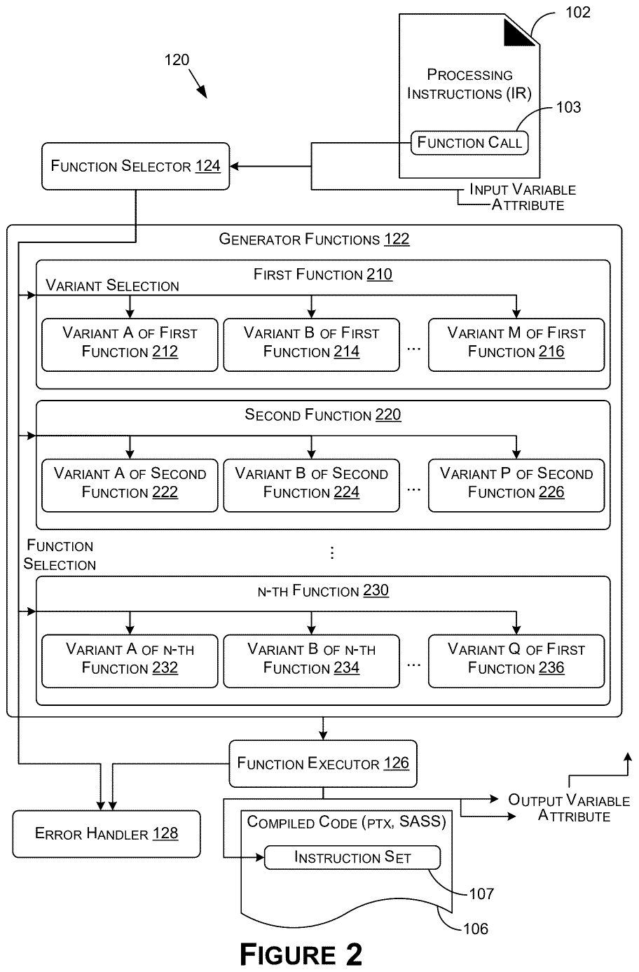

FIG. 2 is a is a functional block diagram of the code generator 120 suitable for implementing at least some implementations of the present disclosure. The code generator 120 can generate code from the processing instructions 102 using a number of generator functions 122 as described herein. The code generator 120 can iteratively process individual functions from the processing instructions 102. By processing the functions, the code generator 120 can generate instructions for the compiled code and output variables that are used by later functions from the processing instructions 102 and their respective generator functions 122. In addition, the code generator 120 can determine (e.g., track, calculate, etc.) the attributes of the variables from each function.

The code generator 120 can receive the processing instructions 102 and process individual operations by iteratively generating compiled code for each operation as necessary based on the operation. For example, the code generator 120 may operate on a function call 103 included in the processing instructions 102. For some function calls 103, the code generator 120 has one or more input variables and respective values of the attributes for the one or more input variables that are used as input for the function call 103. The function call 103 (e.g., the type, identifier, name, etc.) may be provided with the input variable to the function selector 124.

In some implementations, the function selector 124 determines the specific function of the generator functions 122 that should be used based on the function call 103. For example, the function selector 124 can select from any of the generator functions 122 (e.g., a first function 210, a second function 220, a n-th function 230, or any other of the generator functions 122). The function selector 124 can select a variant from the selected function. For example, if the first function 210 is selected, the function selector 124 may select from any of the variants of the first function 210 (e.g., a variant A of the first function 212, a variant B of the first function 214, a variant M of the first function 216, etc.) based on any of the attributes or types of the one or more input variables provided with the function call 103. Similarly, if the second function 220 is selected, the function selector 124 can select any of the variants of the second function 220 (e.g., a variant A of the second function 222, a variant B of the second function 224, a variant P of the second function 226, etc.), or if the n-th function 230 were selected, the function selector 124 may select any of the variants of the n-th function 230 (e.g., a variant A of the n-th function 232, a variant B of the n-th function 234, a variant Q of the n-th function 236, etc.).

If the function selector 124 is unable to select an appropriate function and a variant thereof, the function selector 124 may raise an exception for the error handler 128. Such a situation can arise if an input variable has attribute values for which no variant is defined. For example, the developer may have made a coding error that was not caught by the intermediate compiler 114 or the function used is not supported by the code generator 120. The error handler 128 can process the exception based on the current state of the code generator 120, the configuration of the code generator 120 and/or the function call 103 currently being processed. The error handler 128 can determine to ignore the error, store the error (e.g., to inform the developer) but allow processing to continue, or stop processing further instructions from the processing instructions 102.

In some implementations, the exception can include a potential solution for the error or information related to the error (e.g., variable attributes, etc.) that may be useful to determine the issue. Providing such information to the developer automatically can advantageously reduce developer iterations and time associated with debugging issues.

The selected variant of the selected generator function can be executed by the function executor 126. During execution of the generator function the function executor 126 can generate one or more output variables with values for respective attributes, code or instructions (e.g., instruction set 107 in the compiled code 106), and/or errors for the error handler 128. The error handler 128 can process exceptions from the function executor 126. For example, can perform a corrective action for an error and allow processing to continue. The error handler 128 can, for example, store the error to be presented to the user, but continue processing to allow all potential errors to be identified. A nonlimiting example of an exception that can occur during execution by the function executor 126 includes determining that an allocation for memory will not fit within the memory units of host 140. The function executor 126 can also raise warnings that can be stored by the error handler 128 for display to the developer. For example, execution of a generator function by the function executor 126 can cause a warning to be generated if a memory allocation is inefficient due to its layout.

The data flow of the code generator 120 may be repeated for each function call 103 (e.g., instruction, operation, etc.) of the processing instructions 102. With each iteration, additional variables can be created for use on a future execution of a generator function, errors and/or warnings can be generated and stored by the error handler 128 for display to the developer, and/or instructions can be generated and included in the compiled code 106 for execution by the host 140.

The data flow used by the code generator 120 provides multiple improvements over conventional systems. The function executor 126 can execute a generator function specifically developed for the variant of input variables. The value of the attributes can be calculated within the generator function and output with the output variable (or as part of the output variable). By propagating the value of a binding attribute (e.g., static or dynamic), variables can be precalculated (e.g., code folding) and/or code that cannot be reached (e.g., because of a static input to an “if” statement) can be removed or otherwise optimized without the computational burden and the potential for errors in a manner that is understandable and explainable (e.g., to the developer if issues arise).

In addition to determining if a variable is static or dynamic, values for attributes related to the minimum of a variable, the maximum of a variable, and/or any factors of a variable, can be calculated and propagated as part of the code generation process. Values of such attributes can be used to optimize memory and/or processor allocations. For example, multiple variants of memory allocation functions can be defined for different values of a maximum or minimum attribute or different values of a divisibility attribute with each variant providing different memory allocations (e.g., stride, shape, padding, etc.).

Advantageously, the attributes can also be used to determine errors prior to runtime. Each generator function can assert one or more expectations on the value of any attribute of the input, output, or local variables of the function. If the values of the attributes do not meet the expectations, the function executor 126 can generate an error or exception for the error handler 128 as described herein.

An application of the present disclosure is in generating code that performs memory allocations. The memory allocation, for example of a tensor object, can be described using a layout include a shape and a stride. The shape of a tensor can refer to its dimensionality (e.g., by defining the number of elements along each dimension). For example, a three-dimensional tensor with a shape of (3, 4, 5) has three dimensions, with 3 elements in the first dimension, 4 in the second, and 5 in the third. This shape can be used in organizing the data structure in memory along with the stride. The stride of a tensor indicates how far apart elements of each dimension are stored in memory. Stride values can be used for efficient memory access, as the stride values can specify the step size needed to move from one element to the next within a specific dimension. For example, a two-dimensional tensor with a shape of (3, 3) (e.g., 3 rows and 3 columns). And a stride within the rows of 1 and within the columns of 3, e.g., (3, 1), indicates that to move from one element to the next within a row, the address can step by 1 memory unit, and to move from one row to the next, the memory address step by 3 memory units.

In some implementations, the variables used to generate the shape and/or stride values within the system 100 are statically defined (e.g., provided by the developer as part of the processing instructions 102). The code generator 120 can optimize code by removing the calculations during runtime and generating a function that can pre-allocate memory and/or processing units of the correct size. Additionally or alternatively, the values of the maximum, minimum, and/or divisibility attributes can be used to determine optimal layouts for the tensor so that during processing, memory can be access as quickly as possible. For example, the code generator 120 using the correct generator functions 122 can determine optimal padding to fill memory units that are not fully utilized. Such layouts can ensure that elements are stored contiguously in memory and access patterns are efficient.

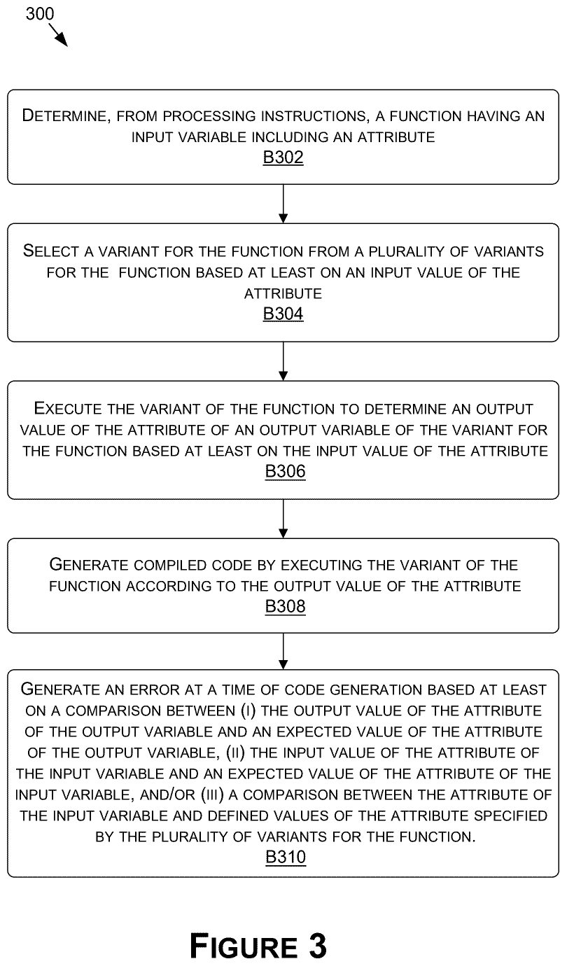

Now referring to FIG. 3, each block of method 300, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for generating code in accordance with some implementations of the present disclosure. In some implementations, the method 300 is performed by the code generator 120. The method 300, at block B302, includes determining, from processing instructions, a function having an input variable including an attribute. A set of processing instructions can be received as part of the process at block B302. The processing instructions can be plain text, formatted text, or any format appropriate for communicating processing instructions. For example, the processing instructions can be the processing instructions 102 from the system 100. The processing instructions can be received by way of computer network, a bus within a single device, or a shared memory location (e.g., shared by the development environment 112 of the deep learning framework 110 and the code generator 120).

The method 300, at block B302, can include identifying a function call from within the processing instructions 102 for which code is to be generated using the method 300. After identifying a function, the method, at block B302, can determine a function (e.g., having the same name, having the same identifier, contained within a visitor class of the same name, etc.) from a library of potential functions appropriate for generating code for the identified function. For example, this aspect of the method 300, at block B302, may be performed by the function selector 124. The function selector 124 may select the appropriate code generation function from the code generation functions 122.

The method 300, at block B304, can include selecting a variant for the function from a plurality of variants for the function based at least on an input value of the attribute. After determining the appropriate function (e.g., from the generator functions 122) the method 300, at block B304, can include examining the input variables that are used by the function call from within the processing instructions. The method 300, at block B304, can include examining the attribute in the input variables and selecting a variant for which the function signature has a variable attribute that matches the value of the attribute of the input variable. In some implementations, the value of the attribute is a member of an enumerated set (e.g., the set {static, dynamic}) and the method 300, at block B304, can include evaluating a match criterion by comparing the value (e.g., the member of the enumeration) of the attribute specified in the function signature with the value of the attribute of the input variable. In some implementations, the value of the attribute is a numeric and the method 300, at block B304, includes evaluating a match criterion by comparing a range specified by the variant and the value of the attribute.

In some implementations, the method 300, at block B304, is a process that is performed by the function selector 124. The scope of operations of the function selector should be considered within the scope of the process performed at block B304.

The method 300, at block B306, can include executing the variant of the function to determine an output value of the attribute of an output variable of the variant for the function based at least on the input value of the attribute. In addition, the method 300, at the block B308 can include generating compiled code by executing the code generation function according to the input value of the attribute. The processes (e.g., operations, steps, etc.), of the block B306 and the block B308, can be performed by the function executor 126. Executing a variant of the function (e.g., any of the generator functions 122) can cause any of the following: (i) code can be emitted (e.g., created, generated, etc.) and stored as one or more instructions or an instruction set, (ii) an output variable can be generated and the values of the variant for the output variable can be propagated from the attributes of the input variables, through the computations of the variant of the function, and to the attributes of the output variables, and/or (iii) and exception or error can be raised (e.g., generated, identified, etc.).

The method 300, at block B310, can include generating an error at a time of code generation based at least on a comparison between (i) the output value of the attribute of the output variable and an expected value of the attribute of the output variable, (ii) the input value of the attribute of the input variable and an expected value of the attribute of the input variable, and/or (iii) a comparison between the attribute of the input variable and defined values of the attribute specified by the plurality of variants for the function.

In some implementations, the method 300 is repeated for all the function calls of the processing instructions (e.g., the processing instructions 102). The method 300 can be performed iteratively. For example, each function call can cause one pass through the method 300. The outputs that are generated by the method 300, at the blocks B306-B310, can depend on the function call being processed by each pass through the method 300. For example, a function call that performs an operation on variables all having a value of static for a binding attribute (e.g., a static variable) may not cause any code to be generated. An operation on static variables can be processed by generating a static output variable for later function calls with a value equal to the result of the function call. In addition, only some function calls will generate an error (e.g., if any of the asserted criteria are not correct).

During iterative performances of the method 300, the outputs during execution of the processes defined by each of the blocks B306-B310 can be stored (e.g., written to disk, saved in memory, etc.). Generated instructions can be saved in the output version of the compiled code (e.g., the compiled code 106). Each instruction can be added to the compiled code (e.g., at the end) in the appropriate form for the target output language. Output variables can be saved in memory by the machine executing the method 300 for use as inputs to functions during later iterations. Additionally or alternatively, errors generated during processing at the block B310 can be saved (e.g., aggregated) for presentation to a developer that generated the original processing instructions. In some implementations, (and, for example, for some errors), execution of the method 300 can be terminated prematurely (e.g., prior to processing all of the function calls in the processing instructions). Terminating the method 300 can be forced based on the severity of the error.

In some implementations, after the method 300 has been executed for all of the function calls within the processing instructions, the generated code can be communicated to a host device upon which the compiled code is to be executed (e.g. the host 140, the GPU 142, and/or the CPU 144). The code can be communicated by way of a network, a shared memory location (e.g., between the code generator 120 and the host 140), or any other suitable method for communication. In some implementations, the results of the executed code are reported to the developer (e.g., using the deep learning framework 110).

In some implementations, the systems and methods described herein can be performed within a development environment for configuring machine learning models (e.g., transformer models, recurrent neural networks, reinforcement learning models, large language models, etc.). For example, the code generation system and methods described herein can be packaged with tools for developing machine learning models including, but not limited to, integrated development environments for high-level languages (e.g., Python, C languages, etc.) and/or with libraries designed for the development of code targeting GPUs (e.g., NVIDIA's CUDA). The systems and methods described herein may also be performed within a simulation environment. For example, the code generation systems and methods described herein can generate code for a GPU that is used to calculate system states (e.g., temperatures, velocities, etc.) of a machine, equipment, or another real-world object within a simulated environment. The simulations can provide data by which the performance of other algorithms (e.g., machine vision models, vehicle control algorithms, etc.) is tested prior to deployment. The generated code can also be used to generate renderings of three-dimensional models of the real-world objects as the simulation progresses.

In some implementations, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed implementations may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some implementations, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in implementations, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in implementations, whereas in other implementations, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

The LLMs/SLMs/VLMs/MMLMs/etc. may be trained and/or executed using code generated by the code generator 120. For example, any of the systems or methods described herein may be implemented within a development environment capable of or designed for producing machine learning models. The machine learning models may include transformer models, recurrent neural network models, long short-term memory models or any other model architecture described herein. The development environment may be used for or designed for generating machine learning models geared towards a variety of applications including LLMs/SLMs/VLMs/MMLMs, automotive applications, simulation and testing, or other applications described herein.

Various types of LLMs/SLMs/VLMs/MMLMs/etc. architectures may be implemented in various implementations. For example, different architectures may be implemented that use different techniques for understanding and generating outputs—such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) may be used, while in other implementations transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular implementation and the task(s) being performed using the LLMs/SLMs/VLMs/MMLMs/etc.

In various implementations, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure may be implemented using various model alignment techniques. For example, in some implementations, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some implementations, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data may be provided with the same input query and prompt (e.g., set of constraints, conditioners, etc.). In one or more implementations, the language models may be different versions of the same foundation model. In one or more implementations, at least one language model may be instantiated as multiple agents—e.g., more than one prompt may be provided to constrain, direct, or otherwise influence a style, a content, or a character, etc., of the output provided. In one or more example, non-limiting implementations, the same language model may be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more implementations, the output from one language model—or version, instance, or agent—maybe be provided as input to another language model for further processing and/or validation. In one or more implementations, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more implementations, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 4A is a block diagram of an example generative language model system 400 suitable for use in implementing at least some implementations of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a SLM, a VLM, a multi-modal LM, etc.). The example generative language model system 400 may be implemented, for example, by code targeting a GPU generated by the system 100 and/or the code generator 120.

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/SLM/VLM/MMLM/etc.). In some implementations, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some implementations, a RAG component 492 (which may include one or more RAG models, and/or may be performed using the generative LM 430 itself) may be used to retrieve additional information to be used as part of the input 401 or prompt. RAG may be used to enhance the input to the LLM/SLM/VLM/MMLM/etc. with external knowledge, so that answers to specific questions or queries or requests are more relevant—such as in a case where specific knowledge is required. The RAG component 492 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some implementations, the input 401 may be generated using the query or input to the model (e.g., a question, a request, etc.) in addition to data retrieved using the RAG component 492. In some implementations, the input processor 405 may analyze the input 401 and communicate with the RAG component 492 (or the RAG component 492 may be part of the input processor 405, in implementations) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some implementations, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such implementations, may contain relevant textual content and metadata about the knowledge graph as well as be integrated with a vector database. In some implementations, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some implementations, graph RAG (e.g., using a graph database) may be combined with standard (e.g., vector database) RAG, and/or other RAG types, to benefit from multiple approaches.

In any implementations, the RAG component 492 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular implementation.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features—such as in the form of a spectrogram (e.g., a mel-spectrogram). In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some implementations, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

In some implementations, instructions for executing the example LMs 430 are generated by the system 100. For example, the LMs 430 may be specified within a deep learning framework 110 within which the code generator 120 is integrated. Additionally or alternatively, the deep learning framework 110 can communicate a representation of the processing instructions for any of example LMs 430. The code generator 120 can convert processing instructions into compiled code capable of executing on host 140 (e.g., the GPU 142 or the CPU 144).

### Example Computing Device

FIG. 5 is a block diagram of an example computing device(s) 500 suitable for use in implementing some implementations of the present disclosure. The computing devices 500, for example, can implement any of the components of the system 100. The computing devices 500 may implement the deep learning framework 110, the code generator 120, the compiler 130 and/or the host 140. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In implementations, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In implementations, one or more of the logic units 520 may be a coprocessor of one or more of the CPU(s) 506 and/or one or more of the GPU(s) 508. In some implementations, instructions are generated by the code generator 120 and communicated to the CPU(s) 506 and/or the GPU(s) 508 (e.g., the GPU 142 and the CPU 144 of the host 140).

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one implementations of the present disclosure. The data center 600 may include a data center infrastructure layer 610, a framework layer 620, a software layer 630, and/or an application layer 640.

In some implementations, a number of computers or other computing resources (e.g., of the example data center 600). The components (e.g., the deep learning framework 110, the code generator 120, the compiler 130 and/or the host 140) may be distributed over any number of resources within the example data center 600. A single component may be implemented by a single resource or by more than one resource. Additionally or alternatively, a single resource may implement more than one of the components of the system 100. In some implementations, the multiplicity of each component type is increased to meet the current demand for that functionality. For example, several instances of the code generator 120 may be operating within the example data center 600 at any point in time. Each instance may be generating code for a different set of processing instructions, for a different application, etc.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one implementation, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) may correspond to a server having one or more of the above-mentioned computing resources. In addition, in some implementations, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one implementation, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one implementation, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one implementation, resource orchestrator 612 may include a software design infrastructure (SDI) management entity for the data center 600. The resource orchestrator 612 may include hardware, software, or some combination thereof.

In at least one implementation, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one implementation, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one implementation, clustered or grouped computing resources may include grouped computing resource 614 at data center infrastructure layer 610. The resource manager 636 may coordinate with resource orchestrator 612 to manage these mapped or allocated computing resources.

In at least one implementation, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one implementation, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more implementations described herein. For example, a machine learning model(s) may be trained by calculating weight parameters according to a neural network architecture using software and/or computing resources described above with respect to the data center 600. In at least one implementation, trained or deployed machine learning models corresponding to one or more neural networks may be used to infer or predict information using resources described above with respect to the data center 600 by using weight parameters calculated through one or more training techniques, such as but not limited to those described herein.

In at least one implementation, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
determine, from processing instructions, a function having an input variable comprising an attribute;
select a variant for the function from a plurality of variants for the function based at least on an input value of the attribute; and
execute the variant of the function to determine an output value of the attribute of an output variable of the variant of the function based at least on the input value of the attribute.

2. The one or more processors of claim 1, wherein the processing circuitry is to generate compiled code by executing the variant of the function according to the output value of the attribute of the output variable.

3. The one or more processors of claim 1, wherein the processing circuitry is to generate an error at a time of code generation based on at least one of:
a comparison between the output value of the attribute of the output variable and an expected value of the attribute of the output variable;
a comparison between the input value of the attribute of the input variable and an expected value of the attribute of the input variable; or
a comparison between the attribute of the input variable and defined values of the attribute specified by the plurality of variants for the function.

4. The one or more processors of claim 1, wherein the attribute indicates whether a value of the input variable is known at a time of code generation.

5. The one or more processors of claim 1, wherein the attribute indicates a minimum value and a maximum value of the input variable.

6. The one or more processors of claim 1, wherein the attribute indicates one or more factors of the input variable.

7. The one or more processors of claim 1, wherein the input variable comprises a shape or a stride for a memory allocation within a graphics processing unit.

8. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

9. A system comprising one or more processors to:
determine, from processing instructions, a function having an input variable comprising an attribute;
select a variant for the function from a plurality of variants for the function based at least on an input value of the attribute;
execute the variant of the function to determine an output value of the attribute of an output variable of the variant of the function based at least on the input value of the attribute; and
generate compiled code using the output value of the attribute.

10. The system of claim 9, wherein the one or more processors are to generate an error at a time of code generation based on at least one of:
a comparison between the output value of the attribute of the output variable and an expected value of the attribute of the output variable;
a comparison between the input value of the attribute of the input variable and an expected value of the attribute of the input variable; or
a comparison between the attribute of the input variable and defined values of the attribute specified by the plurality of variants for the function.

11. The system of claim 9, wherein the attribute indicates whether a value of the input variable is known at a time of code generation.

12. The system of claim 9, wherein the attribute indicates one or more factors of the input variable.

13. The system of claim 9, wherein the input variable comprises a shape or a stride for a memory allocation within a graphics processing unit.

14. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

15. A method comprising:
determining, from processing instructions, a function having an input variable comprising an attribute;
selecting a variant for the function from a plurality of variants for the function based at least on an input value of the attribute;
executing the variant of the function to determine an output value of the attribute of an output variable of the variant of the function based at least on the input value of the attribute; and
generating compiled code using the output value of the attribute.

16. The method of claim 15, further comprising generating an error at a time of code generation based on at least one of:
a comparison between the output value of the attribute of the output variable and an expected value of the attribute of the output variable;
a comparison between the input value of the attribute of the input variable and an expected value of the attribute of the input variable; or
a comparison between the attribute of the input variable and defined values of the attribute specified by the plurality of variants for the function.

17. The method of claim 15, wherein the attribute indicates whether a value of the input variable is known at a time of code generation.

18. The method of claim 15, wherein the attribute indicates one or more factors of the input variable.

19. The method of claim 15, wherein the input variable comprises a shape or a stride for a memory allocation within a graphics processing unit.

20. The method of claim 15, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
